(19) United States
(12) Patent Application Publication
(10) Pub. No.: US 2026/0346385 A1
(43) Pub. Date: Nov. 5, 2026

(54) AUTOMATIC HARDWARE-FASTENING DEVICE

(71) Applicants: Hyundai Motor Company, Seoul (KR); Kia Corporation, Seoul (KR)

(72) Inventor: Ji Eun Jang, Seoul (KR)

(21) Appl. No.: 18/872,255

(22) PCT Filed: Dec. 20, 2022
(86) PCT No.: PCT/KR2022/020782

§ 371 Date: Jul. 15, 2026

(30) Foreign Application Priority Data
Jul. 26, 2022 (KR) 10-2022-0092616

(51) Int. Cl. B23P 19/06; B23P 19/00

(52) U.S. Cl. CPC B23P 19/06; B23P 19/006; B23P 19/007

(57) ABSTRACT

The present invention comprises a base frame: a socket that can be lifted/lowered with respect to the base frame; a circular magazine which can rotate with respect to the base frame, and in which a plurality of pieces of hardware to be inserted into the socket are mounted in a circle; and a holder guide actuator that can switch, at the upper side of the socket, between a state in which the displacement of a circular magazine holder is restricted and a state in which the socket passes therethrough.

### TECHNICAL FIELD

The present disclosure relates to a device configured to automatically fasten hardware such as bolts or nuts.

### BACKGROUND ART

In automobile assembly lines, hardware such as bolts, nuts, and clips are used to fasten various parts.

The fastening of the hardware as described above is a simple and repetitive task and, desirably, it will be done automatically to reduce human error and labor costs.

Furthermore, during the automatic hardware fastening process, errors such as the hardware not being fastened properly may occur, and it would be desirable if the errors could be corrected automatically.

As the related art relative to the above description, KR 10-2021-0061131 A was disclosed.

The description provided above as a related art of the present disclosure is just to assist understanding the background of the present disclosure and should not be construed as being included in the related art known by those skilled in the art.

### DISCLOSURE

### Technical Problem

An objective of the present disclosure is to provide an automatic hardware-fastening device, which is configured to perform automatically fastening of various hardware such as bolts and nuts, to precisely fasten a piece of hardware to a socket to reduce a fastening error and improve a normal mounting rate to reduce the occurrence of the fastening operation errors, and when an error occurs during automatic fastening of the hardware, to automatically solve the problem to enable a post-fastening operation to be continued to improve the productivity while increasing the process operation rate.

### Technical Solution

In order to achieve the above-described objective, there is provided an automatic hardware-fastening device including:
a base frame;
a socket configured to be lifted and lowered with respect to the base frame; and
a circular magazine configured to be rotatable with respect to the base frame, and in which multiple pieces of hardware to be inserted into the socket may be mounted in a circle, wherein the circular magazine may be provided to be slidable with respect to the base frame so that at least one of the mounted multiple pieces of hardware may be located at an upper portion of the socket.

The circular magazine may be provided to be slidable with respect to the base frame so that at least one of the mounted multiple pieces of hardware may be removed from the upper portion of the socket.

The automatic hardware-fastening device may include: a holder guide actuator configured to switch, at an upper space of the socket, between a state in which displacement of a holder of the circular magazine is restricted and a state in which the socket passes therethrough.

The circular magazine may include:
a disk;
the holder having a seating part with a magnet fixing the hardware being open toward an outside space of the disk, the holder being elastically supported by the disk, allowing the seating part to rotate upward with respect to the disk.

The circular magazine may be configured to be linearly slidable with respect to the base frame so that the hardware coupled to the seating part of the holder may be located between the socket and the holder guide actuator.

The automatic hardware-fastening device may include: a sliding plate configured to be linearly slidable with respect to the base frame;
a sliding actuator configured to enable linear sliding of the sliding plate; and
a rotation actuator configured to rotate the circular magazine with respect to the sliding plate.

The disk of the circular magazine may have a mounting hole at a center portion thereof to be attached to or removed from the rotation actuator.

The base frame may include a separation block formed for an upper end of the socket to pass therethrough, and when the socket is lowered and depressed, configured to separate the hardware of the socket from the socket.

The holder guide actuator may be provided above the separation block with the holder of the circular magazine located therebetween; and
a finger of the holder guide actuator may be arranged with a regular spacing from an upper surface of the holder.

The seating part of the holder may be formed with an opening part open toward the outside space of the disk so that a screw part of a bolt may pass therethrough; and
two fingers of the holder guide actuator may include a finger groove to cover the screw part of the bolt seated in the seating part of the holder.

The magnet of the holder may include multiple magnets arranged around a curved portion of the opening part.

The socket may be connected to a torque supply actuator applying a torque for fastening of the hardware;
a lifting and lowering actuator may be provided to lift and lower the torque supply actuator and the socket with respect to the base frame;
the base frame may be connected to a robot; and
a controller may be provided, wherein when an error is determined that the hardware may remain in the socket based on operation information when the torque supply actuator and the socket fasten the hardware, the controller may control the robot to remove the hardware remaining in the socket.

The controller may be configured to compare maximum torque or maximum rotation angle when the torque supply actuator fastens the hardware to a predetermined reference torque or a predetermined reference angle to determine the error.

When maximum torque is less than or greater than a predetermined reference torque range centered on a reference torque, the controller may determine that the error in which the hardware remains in the socket occurs.

When maximum rotation angle is less than or greater than a predetermined reference angle range centered on a reference angle, the controller may determine that the error in which the hardware remains in the socket occurs.

When the controller determines the error determined that the hardware is assumed to remain in the socket, the controller may drive the lifting and lowering actuator so that an upper end of the socket may be depressed into the separation block to separate the hardware from the socket; and the controller may drive the robot to have a posture to allow the hardware between the separation block and the holder guide actuator to fall free.

The controller may be configured to repeat a series of processes of:
lifting the socket by the lifting and lowering actuator to couple the hardware seated on the holder to the socket;
driving the sliding actuator to move the sliding plate so that the circular magazine is removed between the socket and the holder guide actuator;
opening fingers of the holder guide actuator;
lifting the socket by the lifting and lowering actuator, and rotating the socket by the torque supply actuator to fasten the hardware of the socket to a fastening target;
receiving the operation information when the socket fastens the hardware, and when determining that there is no error in which the hardware is assumed to remain in the socket, lowering the socket by the lifting and lowering actuator, and rotating the circular magazine by the rotation actuator to align another piece of hardware to be fastened next toward the socket;
moving the circular magazine linearly toward the socket by the sliding actuator and locating the next-fastened hardware between the socket and the holder guide actuator; and
closing the fingers of the holder guide actuator.

Furthermore, in order to achieve the above-described objective, there may be provided a method for controlling an automatic hardware-fastening device, the method including:
while closing fingers of a holder guide actuator and restricting an upper portion of a seating part of a holder, lifting a socket and coupling a piece of hardware located in the seating part of the holder to the socket;
by a sliding actuator, moving a sliding plate to remove a circular magazine between the socket and the holder guide actuator;
opening the fingers of the holder guide actuator;
lifting the socket with a lifting and lowering actuator, rotating the socket with a torque supply actuator, and fastening the hardware of the socket to a fastening target;
receiving operation information when the socket fastens the hardware, and when an error is determined that the hardware is assumed to remain in the socket occurs, driving the lifting and lowering actuator to depress the socket into the separation block to remove the hardware from the socket; and
driving a robot to have a posture in which the hardware between the separation block and the holder guide actuator falls free.

The method may include: after the driving the robot to have the posture in which the hardware falls free, returning the posture of the robot to a previous posture;
rotating the circular magazine by a rotation actuator and aligning another piece of hardware to be fastened toward the socket;
moving the circular magazine linearly toward the socket by the sliding actuator and locating the hardware to be fastened between the socket and the holder guide actuator;
while closing the fingers of the holder guide actuator and restricting an upper portion of the seating part of the holder, lifting the socket and the hardware to be fastened located in the seating part of the holder to the socket;
by the sliding actuator, moving the sliding plate to remove the circular magazine between the socket and the holder guide actuator;
opening the fingers of the holder guide actuator; and
lifting the socket by the lifting and lowering actuator, rotating the socket by the torque supply actuator, and fastening the hardware to be fastened of the socket to the fastening target.

The method may include: receiving the operation information when the socket fastens the hardware, and when it is determined that there is no error in which the hardware is assumed to remain in the socket, lowering the socket by the lifting and lowering actuator, and rotating the circular magazine by the rotation actuator to align the hardware to be fastened toward the socket;
moving the circular magazine linearly toward the socket by the sliding actuator and locating the hardware to be fastened between the socket and the holder guide actuator; and
closing the fingers of the holder guide actuator.

### ADVANTAGEOUS EFFECTS

According to the present disclosure, the automatic hardware-fastening device can perform automatically fastening of various hardware such as bolts and nuts, precisely fasten a piece of hardware to a socket to reduce a fastening error and improve a normal mounting rate to reduce the occurrence of the fastening operation errors, and when an error occurs during automatic fastening of the hardware, automatically solve the problem to enable a post-fastening operation to be continued to improve the productivity while increasing the process operation rate.

### DESCRIPTION OF DRAWINGS

FIG. 1 is a view illustrating a main configuration of an automatic hardware-fastening device according to the present disclosure;

FIG. 2 is a detail view illustrating a main part of FIG. 1;

FIG. 3 is a view illustrating a circular magazine and a holder;

FIG. 4 is a view illustrating a state immediately before a socket is coupled to a bolt mounted to the holder;

FIG. 5 is a view illustrating a state in which the socket is lifted from the state of FIG. 4 and coupled to the bolt;

FIG. 6 is a view illustrating a state in which the circular magazine is moved backward from the state of FIG. 5;

FIG. 7 is a view illustrating a state in which the backward movement of the circular magazine is completed after the state of FIG. 6;

FIG. 8 is a view illustrating a state in which an error occurs and a piece of hardware remains in the socket;

FIG. 9 is a view illustrating a state in which the socket is depressed downward into the separation block and the piece of hardware is removed from the socket;

FIG. 10 is a view illustrating a state in which the hardware removed from the socket can fall free and a state in which the posture of a base frame is turned 180 ° by a robot from FIG. 9; and

FIG. 11 is a flowchart illustrating an embodiment of a method for controlling the automatic hardware-fastening device according to the present disclosure.

### MODE FOR INVENTION

Hereafter, an embodiment of the present disclosure will be described in detail with reference to the accompanying drawings, and the same or similar components are given the same reference numerals regardless of the numbers of figures and are not repeatedly described.

The suffixes “module” and “part” for the components used in the following description are given or mixed in consideration of only the ease of writing the specification and do not have distinct meanings or roles by themselves.

In the following description, if it is decided that the detailed description of known technologies related to the present disclosure makes the subject matter of the embodiment described herein unclear, the detailed description is omitted. Furthermore, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Singular forms are intended to include plural forms unless the context clearly indicates otherwise.

It will be further understood that the terms “comprise” or “have” used in this specification, specify the presence of stated features, steps, operations, components, parts, a combination thereof, but do not preclude the presence or addition of one or more other features, numerals, steps, operations, components, parts, or a combination thereof.

Furthermore, a unit or a control unit included in names such as a motor control unit (MCU), a hybrid control unit (HCU), etc. is only a widely used term for a controller that controls a specific function of a vehicle, and does not mean a generic function unit.

The controller may include a communication device communicating with other controllers or a sensor to control the function in charge, a memory storing an operation system or a logic command and input/output information, and at least one process performing determination, calculation, and decision necessary for controlling the function in charge.

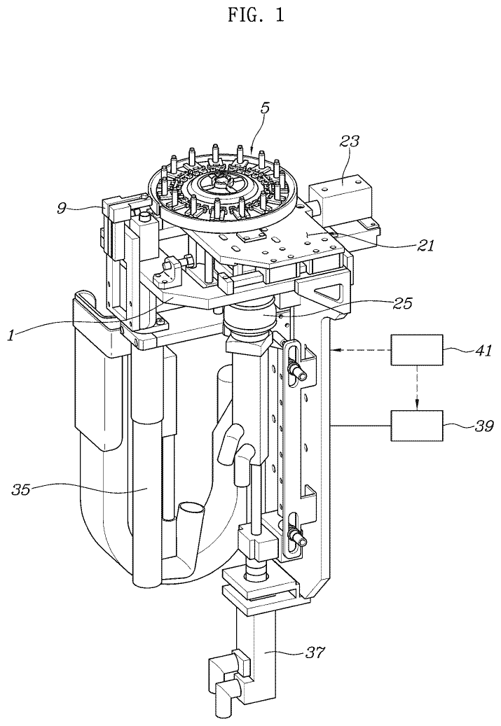

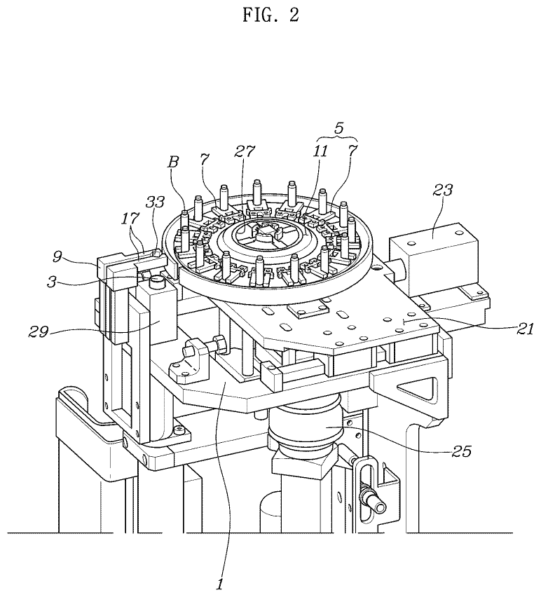

Referring to FIGS. 1 to 4, an embodiment of an automatic hardware-fastening device of the present disclosure includes a base frame 1; a socket 3 installed to be movable upward and downward with respect to the base frame 1; and a circular magazine 5 installed to be rotatable with respect to the base frame 1 and in which a plurality of pieces of hardware to be inserted into the socket 3 are mounted in a circle.

At this point, the circular magazine 5 is installed to be slidable with respect to the base frame 1 so that at least one of the mounted multiple pieces of hardware is located at an upper portion of the socket 3.

Furthermore, the circular magazine 5 may be installed to be slidable with respect to the base frame 1 so that at least one of the mounted multiple pieces of hardware is removed from the upper portion of the socket 3.

In other words, the circular magazine 5 is provided to be slidable with respect to the base frame 1 to locate a piece of hardware at the upper portion of the socket 3 or remove it from the upper portion of the socket 3.

Furthermore, the embodiment of the present disclosure includes a holder guide actuator 9 that may switch, at the upper side of the socket 3, between a state in which the displacement of a holder 7 of the circular magazine 5 is restricted and a state in which the socket 3 passes therethrough.

Furthermore, the circular magazine 5 includes a disk 11; and the holder 7 having a seating part 15 with a magnet 13 fixing the hardware being open outward of the disk 11 and elastically supported by the disk 11 with the seating part 15 rotatable upward with respect to the disk 11.

In other words, the present disclosure is configured to couple a plurality of pieces of hardware mounted to the circular magazine 5 to the socket 3 one by one to fasten the hardware to a fastening target. When the socket 3 is lifted toward the holder 7 to be coupled with the hardware, a finger 17 of the holder guide actuator 9 restricts an elastically upward-rotating range of the seating part 15 of the holder 7. Accordingly, a posture that is advantageous for the hardware to be coupled to the socket 3 is stably maintained, and movement of the hardware is efficiently performed with a posture in which friction between the socket 3 and the hardware is less, which eventually allows the hardware to be precisely and stably coupled to the socket 3.

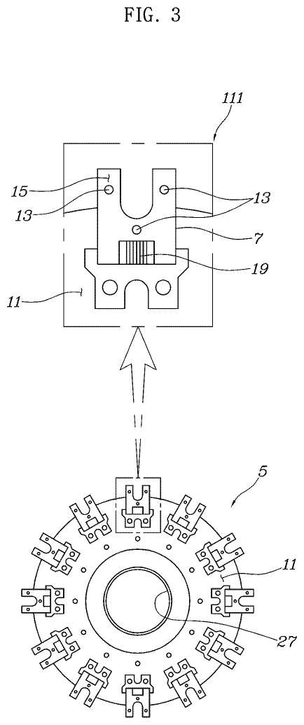

For reference, in FIG. 3, the holder 7 is elastically supported to the disk 11 by a spring 19. Therefore, in a free state, the seating part 15 maintains parallel to the disk 11 so that a head of a bolt or a nut held to the lower side of the seating part 15 by a magnetic force maintains a posture in which it can be inserted into the socket by linear approach of the socket 3, and when the socket 3 presses the holder upward through the hardware, the holder may be rotated upward with respect to the disk 11, and a range in which the holder 7 is rotatable upward is restricted by the finger 17 of the holder guide actuator 9.

Therefore, when the socket 3 is lifted and the hardware is located at the socket 3, the seating part 15 may be rotated upward by a spacing provided, so the hardware may be efficiently seated in the socket 3 in comparison to a structure with the seating part 15 fixed.

The circular magazine 5 is installed to be linearly slidable with respect to the base frame 1 so that the hardware coupled to the seating part 15 of the holder 7 is located between the socket 3 and the holder guide actuator 9.

In other words, with a sliding plate 21 installed to be linearly slidable with respect to the base frame 1 and a sliding actuator 23 installed to linearly slide the sliding plate 21, the holder 7 of the circular magazine 5 may be moved forward and rearward between the socket 3 and the holder guide actuator 9.

Furthermore, the circular magazine 5 is rotated by a rotation actuator 25 installed to rotate the circular magazine 5 to the sliding plate 21, thereby changing the holder 7 and the hardware entering between the socket 3 and the holder guide actuator 9.

Therefore, the circular magazine 5 may be configured such that pieces of hardware to be fastened to a fastening target such as a vehicle, etc. are mounted to the holder 7 in order, and a proper piece of hardware may be fastened to the socket 3 in order.

For example, when pieces of hardware are fastened to the fastening target in order of bolt-bolt-nut-bolt, the pieces of hardware are mounted to holders 7 arranged in a circumferential direction of the circular magazine 5 in order of bolt-bolt-nut-bolt, and the pieces of hardware are supplied to the socket 3 in this order by rotating the circular magazine 5, so it is possible to fasten different types of hardware in order.

Of course, the circular magazine 5 may be configured such that one type of hardware such as a bolt or a nut is mounted and supplied to the socket 3.

The disk 11 of the circular magazine 5 has a mounting hole 27 to which the rotation actuator 25 is attached or removed.

Therefore, when the hardware mounted to the circular magazine 5 is completely used, the used circular magazine 5 is removed from the rotation actuator 25, and a new circular magazine 5 that is completed in the mounting of hardware is coupled to the rotation actuator 25 through the mounting hole 27, so the hardware required for the socket 3 is continuously supplied.

The replacement of the circular magazine 5 as described above may be performed manually or automatically.

The base frame 1 includes a separation block 29 formed for an upper end of the socket 3 to passes, and when the socket 3 is lowered and depressed, separating the hardware of the socket 3 from the socket 3.

In other words, the separation block 29 has a hole 31 in which the socket 3 is inserted into and lifted and lowered. A diameter of the hole 31 is smaller than a diameter of a washer part of the hardware seated in the socket 3. Therefore, when the socket 3 is lowered and depressed into the separation block 29, only the hardware remains on the separation block 29, and separation between the socket 3 and the hardware is achieved.

Therefore, a bolt B, a kind of hardware, is inseparably coupled with a flange or a washer having a diameter larger than a diameter of a bolt head. Likewise, a nut is integrated with a flange or a washer with a diameter greater than a diameter of the nut.

The holder guide actuator 9 is provided above the separation block 29 with the holder 7 of the circular magazine 5 located therebetween, and the finger 17 of the holder guide actuator 9 is arranged to form a spacing from an upper surface of the holder 7.

In other words, as described above, when the socket 3 is moved toward the holder 7 to be coupled to the hardware, the spacing may allow the hardware to be efficiently moved with a posture with less friction between the socket 3 and the hardware, and prevent the posture of the hardware from being excessively changed and allow the hardware to stably maintain the posture advantageous for being coupled to the socket 3, and the spacing may be designed through numerous experiments and analyses.

In the embodiment, the seating part 15 of the holder 7 is formed in an opening part that is open outward of the disk 11 for the screw part of the bolt B to pass therethrough; and a finger groove 33 is formed in two fingers 17 of the holder guide actuator 9 to cover the screw part of the bolt B seated in the seating part 15 of the holder 7.

Furthermore, the magnet 13 of the holder 7 includes multiple magnets arranged around a curved portion of the opening part.

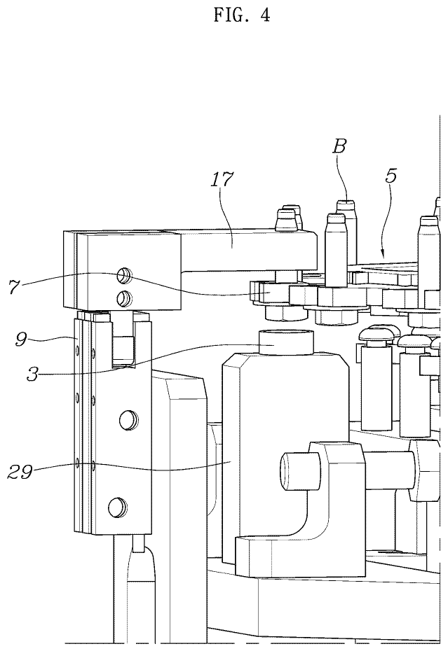

Therefore, before the socket 3 is coupled to the bolt B mounted to the holder 7, as shown in FIG. 4, the head of the bolt B is brought into close contact with a lower portion of the seating part 15 by a magnetic force, and the screw part of the bolt B is located in the finger groove 33 through the seating part 15.

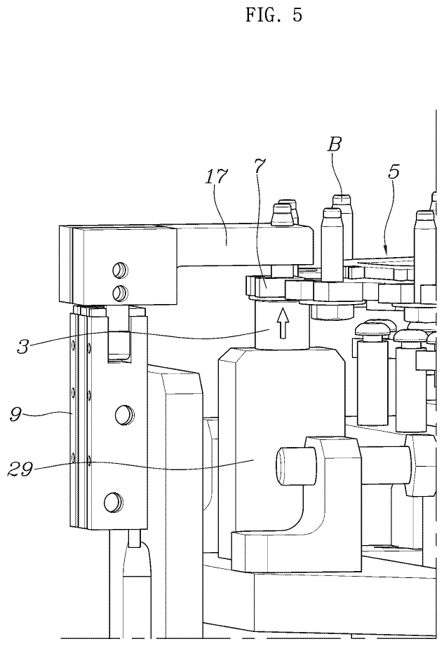

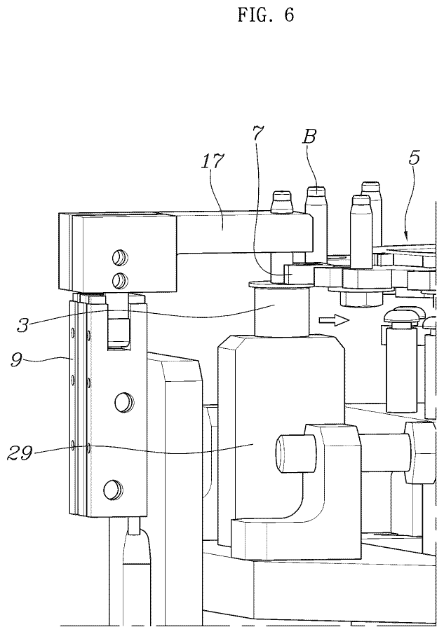

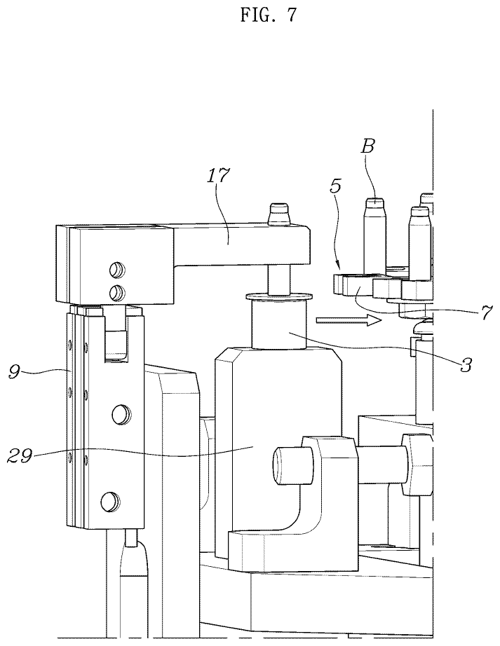

For reference, in FIG. 4, the socket 3 is lifted from the state of FIG. 4, and the hardware is inserted into the finger groove 33 as shown in FIG. 5, and the circular magazine 5 is moved (rearward) by the sliding actuator 23 as shown in FIG. 6. Therefore, the circular magazine 5 is completely spaced apart from the socket 3 and the holder guide actuator 9 as shown in FIG. 7. Thereafter, the socket 3 is lifted to the fastening target and rotated so that the hardware of the socket 3 is fastened to the fastening target.

Next, in order to fasten another piece of hardware to the socket 3, the socket 3 is lowered, the circular magazine 5 is rotated by the rotation actuator 25, and a new piece of hardware is aligned to face the socket 3. Then, the sliding actuator 23 is driven to allow a new piece of hardware mounted to the holder 7 of the circular magazine 5 to enter (move forward) between the socket 3 and the holder guide actuator 9, and then the socket 3 is lifted and a new piece of hardware is coupled to the socket 3.

For reference, the holder guide actuator 9 is configured to switch between the open state in which the two fingers 17 are open from each other and the closed state in which the two fingers 17 are closed to each other. In the embodiment, in the closed state of the two fingers 17, the opposite upper portions of the opening part of the holder 7 are restricted by the two fingers, and in the open state, the socket 3 may pass through a gap between the two fingers.

The socket 3 is connected to a torque supply actuator 35 applying a torque for fastening the hardware; a lifting and lowering actuator 37 is installed to lift and lower the torque supply actuator 35 and the socket 3 with respect to the base frame 1; and the base frame 1 is connected to a robot 39.

Therefore, the base frame 1 may have free spatial position and posture by the robot 39. When the robot 39 locates the base frame 1 below the fastening target, the lifting and lowering actuator 37 lifts the socket 3 so that the hardware is coupled to the socket 3. Then, when the lifting and lowering actuator 37 additionally lifts the socket 3, the hardware of the socket 3 is moved to a fastening position of the fastening target, and then when the torque supply actuator 35 rotates the socket 3, the hardware is fastened to the fastening position of the fastening target.

Meanwhile, the embodiment of the present disclosure includes a controller 41, and based on the operation information when the torque supply actuator 35 and the socket 3 fasten the hardware, an error is determined that the hardware may remain in the socket 3, the controller 41 controls the robot 39 to remove the hardware remaining in the socket 3.

The controller 41 may be configured to compare respectively the maximum torque or the maximum rotation angle when the torque supply actuator 35 fastens the hardware to a predetermined reference torque or a predetermined reference angle to determine the error.

For example, when the maximum torque is less than or greater than the predetermined reference torque range centered on the reference torque, the controller 41 may determine that the error in which the hardware remains in the socket 3 occurs.

At this point, the reference torque may be preset as a regular torque designed to fasten the hardware to the fastening target, and the reference torque range may be preset to a range that is substantially larger or less than the reference torque so that it is difficult to determine that the hardware is normally fastened to the fastening target and can distinguish a situation in which the hardware is likely to remain in the socket 3.

For example, when a normal torque preset to fasten a piece of hardware to a fastening target is 5 Nm, the reference torque is 5 Nm, and the reference torque range may be preset to range from 2 Nm to 8 Nm. In this case, when the maximum torque when the torque supply actuator 35 fastens the hardware is less than 2 Nm or greater than 8 Nm, the controller may determine that the error in which the hardware remains in the socket 3 occurs.

Furthermore, when the maximum rotation angle is less than or greater than the predetermined reference angle range centered on the reference angle, the controller 41 may determine that the error in which the hardware remains in the socket 3 occurs.

At this point, the reference angle may be preset at a regular rotation angle designed to be applied when the hardware is fastened, and the reference angle range may be preset to a range that is substantially larger or less than the reference angle so that it is difficult to determined that the hardware is normally fastened to the fastening target, and can distinguish a situation in which the hardware is likely to remain in the socket 3.

For example, when the regular rotation angle preset to fasten the hardware to the fastening target is 1000 °, the reference angle is 1000 °, and the reference angle range may be preset to range from 500 ° to 1500 °. In this case, when the maximum rotation angle when the torque supply actuator 35 fastens the hardware is less than 500 ° or greater than 1500 °, the controller may determine that the error in which the hardware remains in the socket 3 occurs.

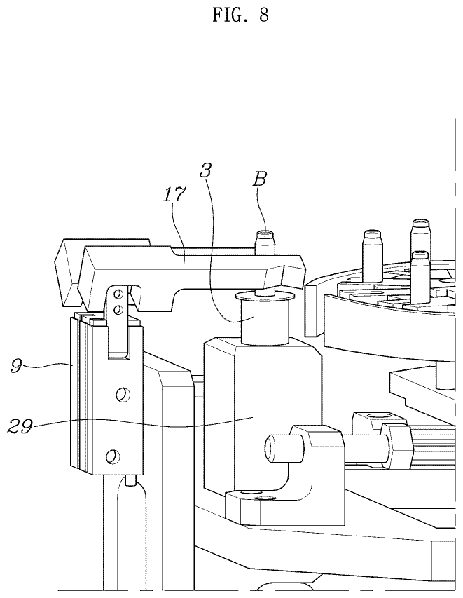

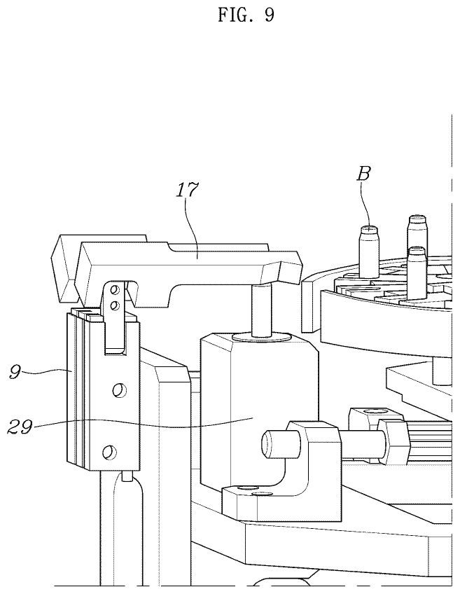

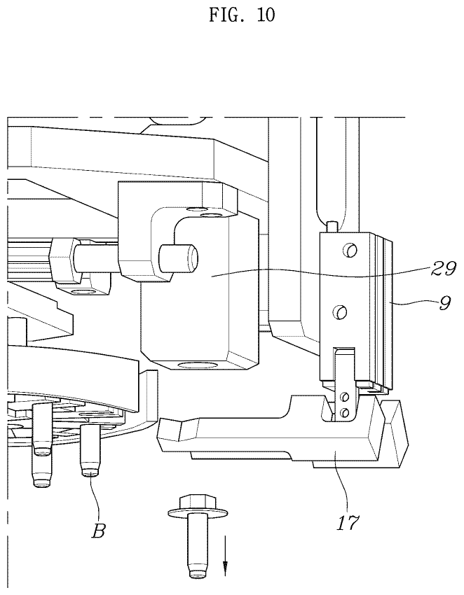

The controller 41 determines that the error in which the hardware is assumed to remain in the socket 3 occurs, the controller 41 drives the lifting and lowering actuator 37 so that the upper end of the socket 3 is depressed into the separation block 29 from the state of FIG. 8 to the state of FIG. 9, thereby separating the hardware from the socket 3; and as shown in FIG. 10, drives the robot 39 to have a posture in which the hardware between the separation block 29 and the holder guide actuator 9 falls free.

At this point, the posture of the base frame 1 in which the hardware can fall free may be, for example as shown in FIG. 10, a state of turning 180 ° compared to FIG. 9. However, the present disclosure is not necessarily limited thereto, and may be multiple postures. Therefore, to ensure removal of the hardware located above the separation block 29, the base frame 1 may be rotated 90 °, rotated to 200 °, and then rotated 90 °.

The controller 41 is configured to lift the socket 3 by the lifting and lowering actuator 37 to couple the socket 3 to the hardware seated in the holder 7; drive the sliding actuator 23 to move the sliding plate 21 so that the circular magazine 5 is removed from the socket 3 and the holder guide actuator 9; open the fingers 17 of the holder guide actuator 9; and then lift the socket 3 by the lifting and lowering actuator 37, and rotate the socket 3 by the torque supply actuator 35 to fasten the hardware of the socket 3 to the fastening target.

Furthermore, the controller 41 is configured to receive the operation information when the socket 3 fastens the hardware, and lower the socket 3 by the lifting and lowering actuator 37 when determining that there is no error in which the hardware is assumed to remain in the socket 3, and rotate the circular magazine 5 by the rotation actuator 25 to align a new piece of hardware to be fastened toward the socket 3; linearly move the circular magazine 5 toward the socket 3 by the sliding actuator 23 to locate a new hardware to be fastened between the socket 3 and the holder guide actuator 9; and close the fingers 17 of the holder guide actuator 9, and the controller is configured to repeat a series of processes.

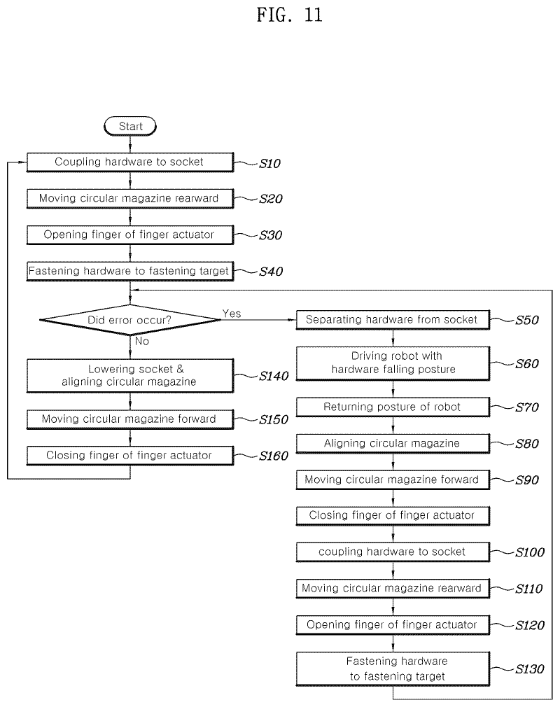

The operation of the controller 41 as described above may be configured as shown in the flowchart of FIG. 11.

According to the present disclosure, the method for controlling the automatic hardware-fastening device includes: as shown in FIG. 11, while the fingers 17 of the holder guide actuator 9 are closed to restrict the upper side of the seating part 15 of the holder 7, lifting the socket 3 so that the hardware located at the seating part 15 of the holder 7 is coupled to the socket 3, S10; by the sliding actuator 23, moving the sliding plate 21 so that the circular magazine 5 is removed between the socket 3 and the holder guide actuator 9, S20; opening the fingers 17 of the holder guide actuator 9, at S30; lifting the socket 3 by the lifting and lowering actuator 37, and rotating the socket 3 by the torque supply actuator 35, so that the hardware of the socket 3 is fastened to the fastening target, at S40; receiving the operation information when the socket 3 fastens the hardware, and when determining that the error in which the hardware remains in the socket 3 occurs, driving the lifting and lowering actuator 37 to depress the socket 3 into the separation block 29, and separating the hardware from the socket 3, at S50; driving the robot 39 to have a posture in which the hardware between the separation block 29 and the holder guide actuator 9 can fall free, at S60.

Furthermore, the control method further includes: after the driving the robot 39 to have a posture in which the hardware can fall free S60, returning the posture of the robot 39 to a previous posture, at S70; rotating the circular magazine 5 by the rotation actuator 25 to align a new piece of hardware to be fastened toward the socket 3, at S80; linearly moving the circular magazine 5 toward the socket 3 by the sliding actuator 23, and locating the new hardware to be fastened between the socket 3 and the holder guide actuator 9, at S90; while the fingers 17 of the holder guide actuator 9 are closed to restrict the upper side of the seating part 15 of the holder 7, lifting the socket 3 to couple the new hardware located at the seating part 15 of the holder 7 to the socket 3, at S100; by the sliding actuator 23, moving the sliding plate 21 so that the circular magazine 5 is removed between the socket 3 and the holder guide actuator 9, at S110; opening the fingers 17 of the holder guide actuator 9, at S120; lifting the socket 3 by the lifting and lowering actuator 37 and rotating the socket 3 by the torque supply actuator 35 to fasten the new hardware of the socket 3 to the fastening target, at S130.

At this point, in the process of the fastening of newly fastened hardware to the fastening target, the hardware is not properly fastened, and the error in which the hardware remains in the socket 3 occurs, the device may alert the fabricator to the occurrence of the error and to stop operation.

Furthermore, the control method may further include: receiving the operation information when the socket 3 fastens the hardware, and when it is determined that there is no error in which the hardware may remain in the socket 3, lowering the socket 3 by the lifting and lowering actuator 37, and rotating the circular magazine 5 by the rotation actuator 25 to align a piece of hardware to be fastened next toward the socket 3, at S140; linearly moving the circular magazine 5 toward the socket 3 by the sliding actuator 23, and locating a piece of hardware to be fastened next between the socket 3 and the holder guide actuator 9, at S150; and closing the fingers 17 of the holder guide actuator 9 at S160.

Although the present disclosure was provided above about specific embodiments shown in the drawings, it is apparent to those skilled in the art that the present disclosure may be changed and modified in various ways without departing from the scope of the present disclosure, which is provided in the following claims.

### DESCRIPTION OF REFERENCE NUMERALS

1: base frame
3: socket
5: circular magazine
7: holder
9: holder guide actuator
11: disk
13: magnet
15: seating part
17: finger
19: spring
21: sliding plate
23: sliding actuator
25: rotation actuator
27: mounting hole
29: separation block
31: hole
33: finger groove
35: torque supply actuator
37: lifting and lowering actuator
39: robot
41: controller
B: bolt

1. An automatic hardware-fastening device comprising:
a base frame;
a socket configured to be lifted and lowered with respect to the base frame; and
a circular magazine configured to be rotatable with respect to the base frame, and in which multiple pieces of hardware to be inserted into the socket are mounted in a circle, wherein the circular magazine is provided to be slidable with respect to the base frame so that at least one of the mounted multiple pieces of hardware is located at an upper portion of the socket.

2. The automatic hardware-fastening device of claim 1, wherein the circular magazine is provided to be slidable with respect to the base frame so that at least one of the mounted multiple pieces of hardware is removed from the upper portion of the socket.

3. The automatic hardware-fastening device of claim 1, further comprising:
a holder guide actuator configured to switch, at an upper space of the socket, between a state in which displacement of a holder of the circular magazine is restricted and a state in which the socket passes therethrough.

4. The automatic hardware-fastening device of claim 3, wherein the circular magazine comprises:
a disk;
the holder having a seating part with a magnet fixing the hardware being open toward an outside space of the disk, the holder being elastically supported by the disk, allowing the seating part to rotate upward with respect to the disk.

5. The automatic hardware-fastening device of claim 4, wherein the circular magazine is configured to be linearly slidable with respect to the base frame so that the hardware coupled to the seating part of the holder is located between the socket and the holder guide actuator.

6. The automatic hardware-fastening device of claim 5, further comprising:
a sliding plate configured to be linearly slidable with respect to the base frame;
a sliding actuator configured to enable linear sliding of the sliding plate; and
rotation actuator configured to rotate the circular magazine with respect to the sliding plate.

7. The automatic hardware-fastening device of claim 6, wherein the disk of the circular magazine has a mounting hole at a center portion thereof to be attached to or removed from the rotation actuator.

8. The automatic hardware-fastening device of claim 6, wherein the base frame comprises a separation block, and the separation block is formed for an upper end of the socket to pass therethrough and, when the socket is lowered and depressed, configured to separate the hardware of the socket from the socket.

9. The automatic hardware-fastening device of claim 8, wherein the holder guide actuator is provided above the separation block with the holder of the circular magazine located therebetween; and
a finger of the holder guide actuator is arranged with a regular spacing from an upper surface of the holder.

10. The automatic hardware-fastening device of claim 9, wherein the seating part of the holder is formed with an opening part open toward the outside space of the disk so that a screw part of a bolt passes therethrough; and
two fingers of the holder guide actuator comprise a finger groove to cover the screw part of the bolt seated in the seating part of the holder.

11. The automatic hardware-fastening device of claim 10, wherein the magnet of the holder includes multiple magnets arranged around a curved portion of the opening part.

12. The automatic hardware-fastening device of claim 8, wherein the socket is connected to a torque supply actuator applying a torque for fastening of the hardware;
a lifting and lowering actuator is provided to lift and lower the torque supply actuator and the socket with respect to the base frame;
the base frame is connected to a robot; and
a controller is provided, wherein when an error is determined that the hardware is assumed to remain in the socket based on operation information when the torque supply actuator and the socket fasten the hardware, the controller controls the robot to remove the hardware remaining in the socket.

13. The automatic hardware-fastening device of claim 12, wherein the controller is configured to compare maximum torque or maximum rotation angle when the torque supply actuator fastens the hardware to a predetermined reference torque or a predetermined reference angle to determine the error.

14. The automatic hardware-fastening device of claim 12, wherein when maximum torque is less than or greater than a predetermined reference torque range centered on a reference torque, the controller determines that the error in which the hardware remains in the socket occurs.

15. The automatic hardware-fastening device of claim 12, wherein when maximum rotation angle is less than or greater than a predetermined reference angle range centered on a reference angle, the controller determines that the error in which the hardware remains in the socket occurs.

16. The automatic hardware-fastening device of claim 12, wherein when the controller determines the error determined that the hardware is assumed to remain in the socket, the controller drives the lifting and lowering actuator so that an upper end of the socket is depressed into the separation block to separate the hardware from the socket; and
the controller drives the robot to have a posture to allow the hardware between the separation block and the holder guide actuator to fall free.

17. The automatic hardware-fastening device of claim 12, wherein the controller is configured to repeat a series of processes of:
lifting the socket by the lifting and lowering actuator to couple the hardware seated on the holder to the socket;
driving the sliding actuator to move the sliding plate so that the circular magazine is removed between the socket and the holder guide actuator;
opening fingers of the holder guide actuator;
lifting the socket by the lifting and lowering actuator, and rotating the socket by the torque supply actuator to fasten the hardware of the socket to a fastening target;
receiving the operation information when the socket fastens the hardware, and when determining that there is no error in which the hardware is assumed to remain in the socket, lowering the socket by the lifting and lowering actuator, and rotating the circular magazine by the rotation actuator to align another piece of hardware to be fastened next toward the socket;
moving the circular magazine linearly toward the socket by the sliding actuator and locating the hardware to be fastened next between the socket and the holder guide actuator; and
closing the fingers of the holder guide actuator.

18. A method for controlling an automatic hardware-fastening device, the method comprising:
while closing fingers of a holder guide actuator and restricting an upper portion of a seating part of a holder, lifting a socket and coupling a piece of hardware located in the seating part of the holder to the socket;
by a sliding actuator, moving a sliding plate to remove a circular magazine between the socket and the holder guide actuator;
opening the fingers of the holder guide actuator;
lifting the socket with a lifting and lowering actuator, rotating the socket with a torque supply actuator, and fastening the hardware of the socket to a fastening target;
receiving operation information when the socket fastens the hardware, and when an error is determined that the hardware is assumed to remain in the socket occurs, driving the lifting and lowering actuator to depress the socket into the separation block to remove the hardware from the socket; and
driving a robot to have a posture in which the hardware between the separation block and the holder guide actuator falls free.

19. The method of claim 18, further comprising:
after the driving the robot to have the posture in which the hardware falls free, returning the posture of the robot to a previous posture;
rotating the circular magazine by a rotation actuator and aligning another piece of hardware to be fastened next toward the socket;
moving the circular magazine linearly toward the socket by the sliding actuator and locating the hardware to be fastened next between the socket and the holder guide actuator;
while closing the fingers of the holder guide actuator and restricting an upper portion of the seating part of the holder, lifting the socket and the hardware to be fastened next located in the seating part of the holder to the socket;
by the sliding actuator, moving the sliding plate to remove the circular magazine between the socket and the holder guide actuator;
opening the fingers of the holder guide actuator; and
lifting the socket by the lifting and lowering actuator, rotating the socket by the torque supply actuator, and fastening the hardware to be fastened next of the socket to the fastening target.

20. The method of claim 18, further comprising:
receiving the operation information when the socket fastens the hardware, and when it is determined that there is no error in which the hardware is assumed to remain in the socket, lowering the socket by the lifting and lowering actuator, and rotating the circular magazine by the rotation actuator to align another piece of hardware to be fastened next toward the socket;
moving the circular magazine linearly toward the socket by the sliding actuator and locating the hardware to be fastened next between the socket and the holder guide actuator; and
closing the fingers of the holder guide actuator.
